(19) United States
(12) Patent Application Publication
(10) Pub. No.: US 2021/0207736 A1
(43) Pub. Date: Jul. 8, 2021

(54) VALVE LOCKOUT DEVICE

(71) Applicant: LOTO SAFETY PRODUCTS DMCC, Dubai (AE)

(72) Inventors: Yusufi Fakhruddin BHANPURAWALA, Dubai (AE); Lai QIYANG, Dubai (AE); Qaid Zohar Zakiuddin SHAHPURWALA, Dubai (AE)

(21) Appl. No.: 16/068,834

(22) PCT Filed: Nov. 27, 2017
(86) PCT No.: PCT/IB2017/057411

§ 371 Date: Jul. 9, 2018

(30) Foreign Application Priority Data
Sep. 12, 2017 (IN) 201741032257

(51) Int. Cl. F16K 35/10

(52) U.S. Cl. CPC F16K 35/10

(57) ABSTRACT

The present disclosure relates to lockout devices. More particularly, but not exclusively relates to lockout devices for preventing unauthorized operation of valves. The lockout device comprises a first cover and a second cover. The first cover configured to cover a first portion of the handle and the second cover configured to enclose a second portion of the handle. The first and second cover are adapted to be coupled to each other to selectively enclose the handle in a closed condition of the lockout device. An aperture is defined by the first cover and the second cover to accommodate an element extending perpendicular to the plane and through the lockout device in the closed condition such the first cove and/or the second cover is configured to support an add-on cover to selectively cover the aperture to prevent tampering of the valve.

### CROSS-REFERENCE TO RELATED APPLICATIONS

This application is a national stage application of International Application No. PCT/IB2017/057411, filed on Nov. 27, 2017, which claims foreign priority to Indian Patent Application Serial No. 201741032257 filed on Sep. 12, 2017, the contents of which are incorporated herein by reference in their entireties.

### TECHNICAL FIELD

The present disclosure relates to lockout devices. More particularly, but not exclusively relates to lockout devices for preventing unauthorized operation of valves.

### BACKGROUND

A valve is employed to control the flow of a substance through a passage such as tubing or piping. Valves can be actuated by rotating a handle such as hand wheel, T-shaped handle or a handle with a plurality of spokes, to an open position, closed position or a regulated position between open and closed as desired to control the flow of materials through a pipeline. Typically, valve lockout devices are frequently used to prevent the valve from being operated by any unauthorised personal when safety and isolation of valve is of a considerable significance as per safety requirements, practices and industrial regulations.

The conventional valve lockout devices can fit a particular type of valve model only. This scenario is more pertinent when the operator wants to use a single valve lockout device for securing any one of the hand wheel type valve and a rising stem wheel valve model. The conventional valve lockout devices have special structures to secure and accommodate a rising stem wheel valve model (where the stem extends above the valve handle). These special structures must be irreversibly broken or separated apart to form an opening to accommodate a rising stem, for installing the lockout device over the rising stem of wheel valve. These special structures are generally one-time usable knockout elements which can be separated from the lockout devices either manually or with a tool such as a pair of pliers. The lockout device with separated knockout element are not fit for reuse with a hand wheel type valve because the opening formed after removing the knockout element can allow unauthorized manipulation of the valve.

Furthermore, the conventional valve lockout devices have cut-away opening or apertures to allow the device to fit around a stem of the valve. These cut away openings can allow unauthorized access to the valve handle using any longitudinal object such as a stick, a screw driver, etc. Additionally, various other complex lockout devices are available which necessitate fitting and operation by a specialist, which may be problematic. Accordingly, a need exists for a valve lockout device that addresses one or more above discussed disadvantages and other associated problems with the conventional lockout devices.

### SUMMARY

The present disclosure provides a lockout device for protecting a valve having a handle extending along a plane and the handle being rotatable by a user to operate the valve. The lockout device comprises a first cover configured to cover a first portion of the handle and a second cover configured to enclose a second portion of the handle. To prevent tampering with the valve, the first cover and the second cover are adapted to be coupled to each other to selectively enclose the handle in a closed condition of the lockout device. An aperture is defined by the first cover and the second cover to accommodate an element extending perpendicular to the plane and through the lockout device in the closed condition. The first cover or the second cover is configured to support an add-on cover to selectively cover the aperture to prevent tampering of the valve. The aperture is top aperture to accommodate an element extending above and through the top surface of the lockout device, and the add-on cover is plate adapted to cover the top aperture. The plate is movable between a covered position covering the top aperture and an uncovered position uncovering the top aperture. A set of guide channels is provided on the first cover to slidably support the plate in the covered position and the uncovered position. The guide channels are provided on an inner surface of the first cover. further, plate holding channels are provided on the first cover to retain and hoard the plate in the uncovered position. The plate has a first end configured to be supported by the set of guide channels provided on the first cover and a second end configured of semi-circular shape to cover the top aperture.

The first cover is configured to support the add-on cover, and the second cover comprises a first quadrant to cover a part of the second portion and a second quadrant to cover a remaining part of the second portion. The first quadrant and the second quadrant are coupled to the first cover and configured to rotate about an axis extending perpendicular to the plane to selectively enclose the handle.

The aperture is a bottom aperture to accommodate a stem of the valve extending below and through the bottom surface of the lockout device, and the add-on cover is a bush adapted to extend from the bottom aperture and covers at least a portion of the stem to prevent tampering with the valve. The first cover and the second cover are provided with annular grooves proximate to the bottom aperture to support the bush. The bush comprises a flange portion configured to be supported by the first cover and the second cover and a cylindrical wall portion adapted to cover the at least portion of the stem. The bush has a cut extending along its longitudinal axis to allow entry of the stem in the bush. The lockout device further comprises a first sleeve, including at least one first locking aperture, projecting outwardly from outer periphery of the first quadrant, and a second sleeve, including at least one second locking aperture, projecting outwardly from outer periphery of the second quadrant. The first locking aperture is configured to align with the second locking aperture when the lockout device is the closed condition, for receiving a locking device for securing and retaining the lockout device in closed condition.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a top perspective view of a valve lockout device in partially open position in accordance with an embodiment of the present disclosure;

FIG. 2 illustrates a bottom perspective view of a first cover in accordance with an embodiment of the present disclosure;

FIG. 3 illustrates a perspective view of the first quadrant and the second quadrant in accordance with an embodiment of the present disclosure;

FIG. 4 illustrates a plate of the valve lockout device in accordance with an embodiment of the present disclosure;

FIG. 5 illustrates guide channels of the valve lockout device in accordance with an embodiment of the present disclosure;

FIG. 6 illustrates plate holding channels of the valve lockout device in accordance with an embodiment of the present disclosure;

FIG. 7 illustrates application of valve lockout device on a handle of hand wheel type valve in accordance with an embodiment of the present disclosure;

FIG. 8 illustrates application of valve lockout device for rising stem wheel valve in accordance with an embodiment of the present disclosure; and

FIG. 9 illustrates application of valve lockout device with bush in accordance with an embodiment of the present disclosure; and

FIG. 10 illustrates bush in accordance with an embodiment of the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or process that comprises a list of components or steps does not include only those components or steps but may include other components or steps not expressly listed or inherent to such setup or device or process. In other words, one or more elements in a system or apparatus proceeded by “comprises . . . a” does not, without more constraints, preclude the existence of other elements or additional elements in the system or apparatus.

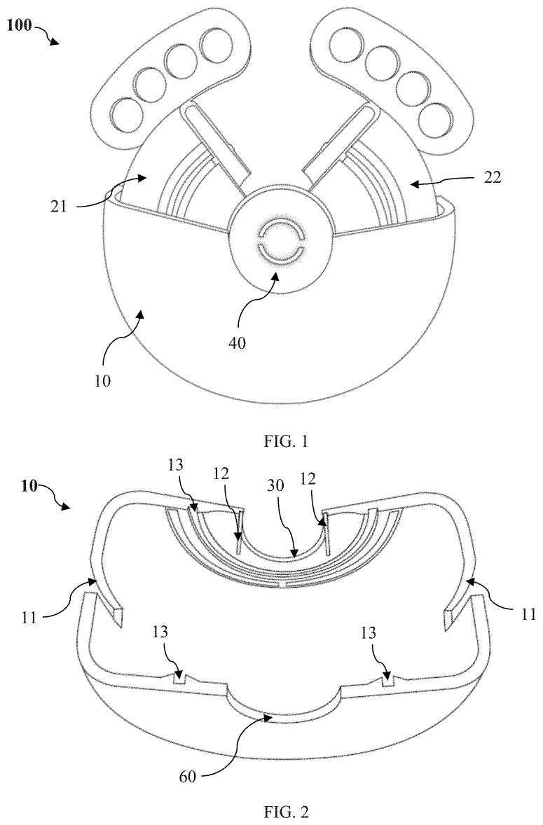

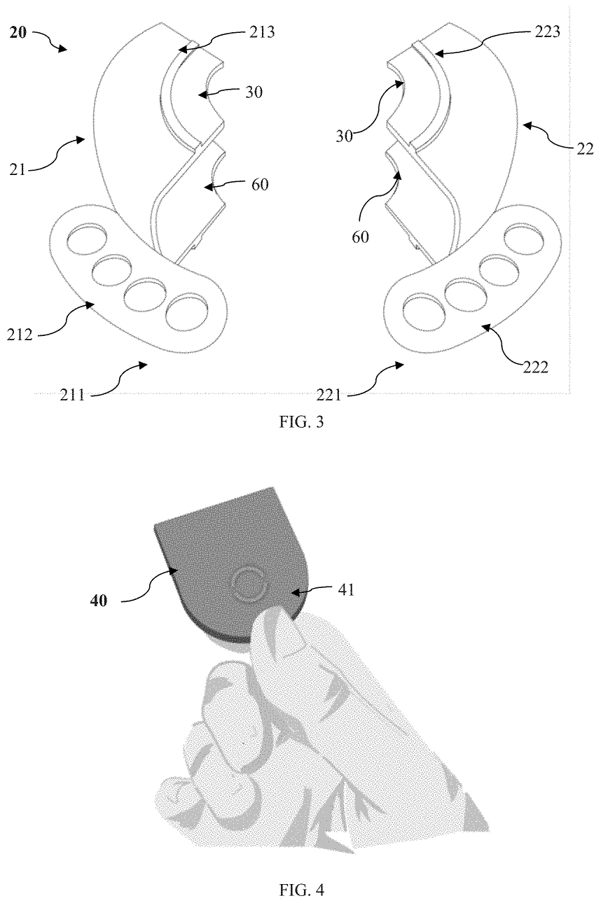

Embodiments of the present disclosure, relate to a lockout device 100 for protecting valve from tampering. The valve has a handle extending along a plane and the handle is rotatable by a user to operate the valve. The handle is generally circular or round in shape. However, it may be understood that the handle can be of any other shape on which the lockout device 100 as disclosed herein can be applied. As, shown in FIGS. 1 to 3, the lockout device 100 has a first cover 10 configured to cover a first portion of the handle and a second cover 20 configured to enclose a remaining second portion of the handle. As shown in FIG. 2, the first cover 10 is substantially a hollow semi-circular shell with an open diametrical side for receiving the first portion of the handle. The first cover 10 and the second cover 20 are adapted to be coupled to each other to selectively enclose the handle when the lockout 100 device is in a closed condition, to prevent tampering with the valve.

The second cover 20 is configured to cover the second portion of the handle, the second portion being the portion of the handle that is not covered by the first cover. In the embodiment as shown herein, the second cover is formed in two parts to cover the second portion. Thus, the second cover has a first quadrant 21 to cover a part of the second portion and a second quadrant 22 to cover a remaining part of the second portion. The first quadrant 21 and the second quadrant 22 are substantially a hollow quadrant shell having an open diametric sector side. The first quadrant 21 and the second quadrant 22 are coupled to the first cover 10 and are configured to rotate about an axis extending perpendicular to the plane of the first cover to selectively enclose the handle. The first cover, the first quadrant 21 and the second quadrant 22 are designed and arranged such that when the lockout device 100 is in the closed position, they together completely cover the handle. In the embodiment as shown, the first quadrant 21 and the second quadrant 22 rotatably nest into the first cover 10 in an open condition of the lockout device 100. In open condition of the lockout device 100, as the first quadrant 21 and the second quadrant 22 are nested into the first cover 10, at that instance the lockout device contemplates a semi-circular hollow shell.

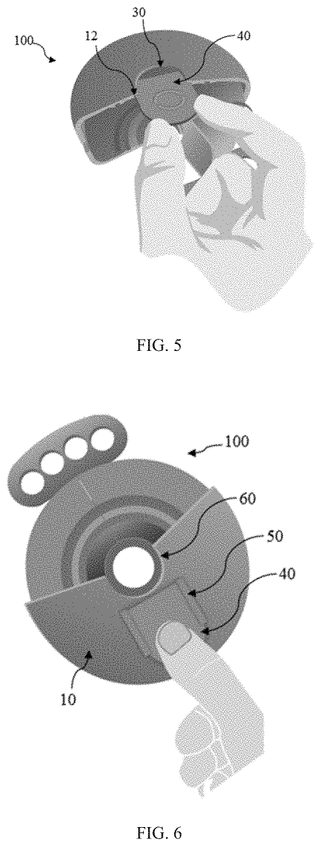

As shown in FIG. 5, the first cover 10 further has at least one channeled pathway 13 interior of the first cover 10. Also, the first quadrant 21 and the second quadrant 22 further includes at least one guide paths 213, 223 projecting outwardly to co-operably engage with said channeled pathway 13 such that the first quadrant 21 and second quadrant 22 slidably nest into the first cover 10.

The first quadrant 21 further has a first sleeve 211 projecting outwardly from outer periphery of the quadrant shell and the sleeve 211 has at least one first locking aperture 212. The second quadrant 22 has a second sleeve 221 projecting outwardly from outer periphery of the second quadrant shell and the second sleeve 221 has at least one second locking aperture 222. In the closed condition of the lockout device 100, the first locking aperture 212 of the first quadrant 21 is configured to align with the second locking aperture 222 of the second quadrant 22 for receiving a locking device for securing the device 100 in the closed position. The locking device can be a padlock to prevent rotation of first quadrant 21 and the second quadrant 22, and to secure the lockout device 100 in the closed condition or closed position. Any padlock with a shackle that may be passed through the locking apertures 212, 222 or any suitable locking devices such as a chain link, or hasp staple and like can be utilised to prevent use or tampering of the lockout device 100. In an embodiment of the present disclosure, the first cover 10 further comprises of slots 11, as shown in FIG. 1, on the outer periphery of the semi-circular shell to accommodate the outwardly projecting sleeves 211, 221 when the first quadrant 21 and the second quadrant 22 are nested within the first cover 10 in the open condition of the lockout device 100.

A top aperture 30 is defined by the top portion of the first cover 10 and the second cover 20 to accommodate an element extending perpendicular to the plane and through the lockout device 100 in the closed condition. The top aperture 30 functions as an opening to accommodate rising stem of wheel valve that may extend above and through the lockout device 100. Additionally, the first cover 10 and the second cover 20 define a bottom aperture 60 to accommodate a stem of the valve that extends below and through the lockout device 100 when the lockout device 100 is applied on the valve. To prevent tampering with the valve through the top aperture 30 or the bottom aperture 60, the first cover 10 and/or the second cover 20 is configured to support an add-on cover.

In an embodiment, the add-on cover may be a plate 40 as shown in FIG. 4. The plate 40 is adapted to selectively cover the top aperture 30 and to prevent tampering of the valve. The plate 40 is movable between a covered position covering the top aperture 30 and an uncovered position uncovering the top aperture 30. The plate 40 is substantially rectangular piece with one semi-circular end 41.

The plate 40 is configured to be supported by a set of guide channels 12 provided on the first cover 10 and the semi-circular end 41 is configured to cover the top aperture 30. As shown in FIG. 5, the set of guide channels 12 are provided on an inner surface of the first cover 10 to slidably support the plate 40 in the covered position and the uncovered position. Further, in an embodiment, as shown in FIG. 6, a plate holding channel 50 is provided on the first cover 10 to retain and hold the plate 40, after the top aperture 30 is uncovered by removing the plate 40 from the set of guide channels 12. Thus, when the lockout device 100 is to be applied on a rising stem type valve, the plate 40 may be removed and stored on plate holding channels 50. Whereas, when the lock device is to be applied on a normal handwheel type valve, the plate 40 may put back in the guide channels 12 for covering the top aperture 30.

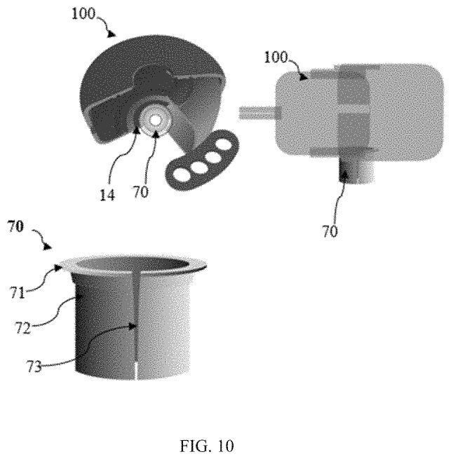

In an embodiment, the add-on cover may be a bush 70 as shown in FIGS. 9 and 10. The bush may be used with the lock-out device to selectively cover the bottom aperture 60 and to prevent tampering with the valve or the valve stem. The bush 70, when installed with the lockout device 100 on the valve, is adapted to extend from the bottom aperture 60 and covers at least a portion of the stem to prevent tampering with the valve or the valve stem. The bush 70 has a flange portion 71 configured to be supported by the first cover 10 and the second cover 20, and a cylindrical wall portion 72 adapted to cover the at least portion of the stem. In the embodiment as shown, the flange portion extends along a plane perpendicular to the longitudinal axis of the cylindrical portion. Further as shown in FIG. 10, the first cover 10 and the second cover 20 are provided with annular grooves 14 proximate to the bottom aperture 60 to support the flange portion 71 of the bush 70. The bush 70 may have a cut 73 extending along its longitudinal axis to allow entry of the stem of the valve in the bush 70 during installation of the lockout device 100 on the valve. The bush may be made of any suitable material such as plastic, rubber, fibre, etc.

In an embodiment, the lockout device 100 further comprises of a protrusion to retain the plate 40 in the covered position. The protrusions may block a sliding movement of the plate 40 on the guide channels 12 when the lockout device 100 is in a closed condition. In the embodiment as shown, the protrusions are provided on the plate 40 as shown in FIG. 1. In an alternate embodiment, suitable protrusions may be provided on the inner surface of the first cover and/or the second cover to have a similar effect of blocking any sliding movement of the plate 40, such that the plate 40 is maintained in the covered position when the lockout device 100 is locked in the closed position.

In an embodiment, the lockout device 100 or any of its components may be manufactured out of plastics or metal or combination of both, or any other suitable material as required.

The following paragraph(s) describe the operation of the lockout device 100 according to an embodiment of the present disclosure.

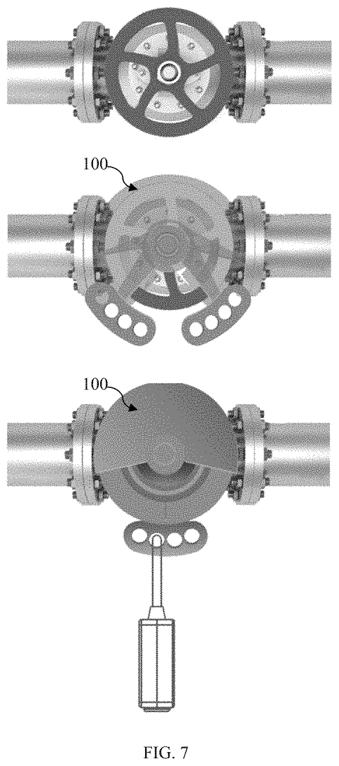

The locking device 100 can be used for the purpose of locking any industrial and commercial valves. Similar to the usage of a conventional lock, the valve can be a retained in desired condition by enclosing the wheel handle of the valve within the lockout device 100, as illustrated in FIG. 7. This way access to the wheel may be prevented. Initially, the lockout device 100 is in the open condition, wherein the first quadrant 21 and the second quadrant 22 are nested into the first cover. For installing the lockout device on a normal handwheel type valve, the operator may first insert the plate 40 in the guide channels 12. This step may be skipped if the lockout device 100 is applied on a rising stem type valve. Then the operator may put the bush 70 onto the stem. Then, the operator may, while placing the flange 71 of the bush 70 on the grooves 14 defined on the first cover 10 and the second cover 20, enclose the first portion of the handle by housing or covering the first portion of the handle with the first cover 10. Once the first portion is covered, the first quadrant 21 and the second quadrant 22 may be slid to rotate and cover the remaining second portion of the handle, as shown in FIG. 7. At this instance, the lockout device 100 reaches the closed condition wherein the first locking aperture 212 of the first quadrant 21 gets aligned with the second locking aperture 222 of the second quadrant 22. The lockout device 100 can be retained in the closed condition by utilising any padlock to secure the lockout device 100 by inserting and locking the shackle of the padlock inside the locking apertures.

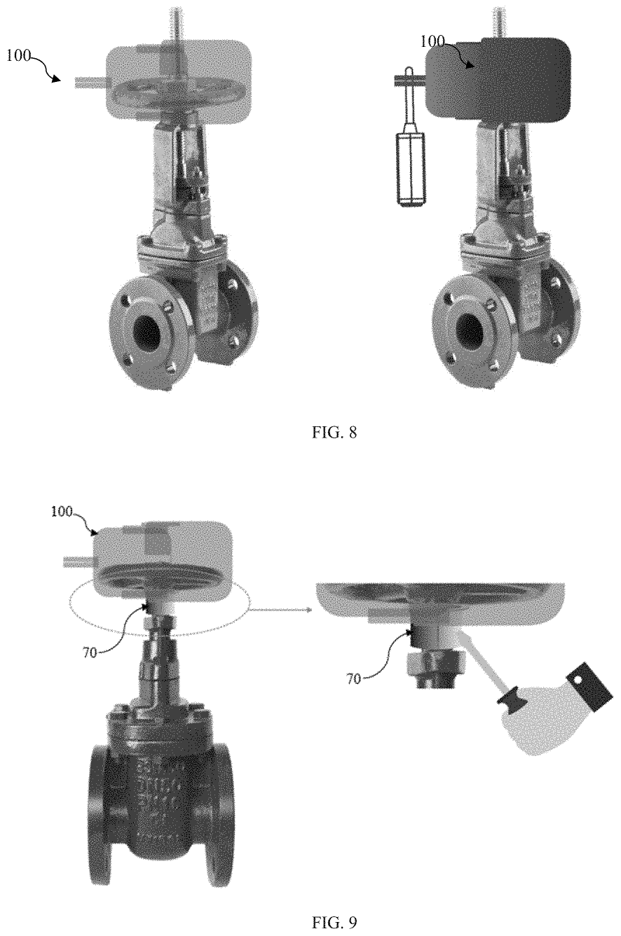

Similarly, the lockout device 100 can be employed for enclosing a raising stem type wheel valve, as illustrated in FIG. 8. Initially, the operator has to remove the plate 40, uncovering the top aperture 30, from the guide channels 12 and can hoard the plate within the plate holding channels 50 for further application. The top aperture accommodates raising stem of wheel valve. Consequently, the operator encloses the first portion of the handle by housing the first portion with the first cover and followed by covering the second portion of the handle, by rotating the first quadrant 21 and the second quadrant 22 towards each other. At this instance, the lockout device 100 reaches the closed condition and the first locking aperture 22 of the first quadrant 20 gets aligned with the second locking aperture 32 of the second quadrant 30. The lockout device 100 can be retained in the closed condition by utilising any padlock to secure the lockout device 100 by inserting and locking the shackle of the padlock within the locking apertures 212, 222.

Accordingly, the lockout device 100 may either be installed without the plate 40 or with the plate 40 stored in the plate holding channels 50. Also, the lockout device 100 as disclosed herein may be used with both rising stem type and a normal handwheel type valve. Use of add-on cover prevents tampering with the valve through the top aperture 30 or the bottom aperture 60. The top aperture 30 may be covered by the plate 40 and the bottom aperture 60 may be covered by the bush 70. Thus, preventing tampering with the handle of the wheel valve.

Further, the present disclosure provides for reuse of the lockout device with a reusable plate to cover or uncover the top aperture of the lockout device based on user requirements. Further the bush 70 of the lockout device 100 also protects the valve from tampering by covering the valve stem positioned below the lockout device. The cut provided in the bush 70 further facilitates easy application of the bush on the stem. Furthermore, the lockout device as described herein can be compactly packed by inserting multiple smaller size lockout devices of various sizes within a large size lockout device while keeping the lockout devices in open condition.

In the detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The description is, therefore, not to be taken in a limiting sense.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Lockout device |
| 10 | First cover |
| 11 | Slots |
| 12 | Set of guide channels |
| 13 | Channeled pathways |
| 14 | Annular groove |
| 20 | Second cover |
| 21 | First quadrant |
| 211 | Sleeve |
| 212 | Locking aperture |
| 213 | Guide paths |
| 22 | Second quadrant |
| 221 | Sleeve |
| 223 | Guide paths |
| 222 | Locking aperture |
| 30 | Top aperture |
| 40 | Plate |
| 41 | Semi-circular end |
| 50 | Plate holding channels |
| 60 | Bottom aperture |
| 70 | Bush |
| 71 | Flange portion |
| 72 | Cylindrical wall portion |
| 73 | Cut |

1. A lockout device 100 for protecting a valve from tampering, the valve having a handle extending along a plane and the handle being rotatable by a user to operate the valve, the lockout device 100 comprising:
a first cover 10 configured to cover a first portion of the handle; and
a second cover 20 configured to enclose a second portion of the handle, the first cover 10 and the second cover 20 adapted to be coupled to each other to selectively enclose the handle in a closed condition of the lockout device 100, to prevent tampering with the valve;
an aperture defined by the first cover 10 and the second cover 20 to accommodate an element extending perpendicular to the plane and through the lockout device 100 in the closed condition;
wherein the first cover 10 or the second cover 20 is configured to support an add-on cover to selectively cover the aperture to prevent tampering of the valve.

2. A lockout device 100 as claimed in claim 1, wherein the aperture is a top aperture 30 to accommodate an element extending above and through the top surface of the lockout device 100, and the add-on cover is plate 40 adapted to cover the top aperture 30.

3. A lockout device 100 as claimed in claim 2, wherein the plate 40 is movable between a covered position covering the top aperture 30 and an uncovered position uncovering the top aperture 30.

4. A lockout device as claimed in claim 3, wherein a set of guide channels 12 is provided on the first cover 10 to slidably support the plate 40 in the covered position and the uncovered position.

5. A lockout device 100 as claimed in claim 4, wherein the guide channels 12 are provided on an inner surface of the first cover 10.

6. A lockout device 100 as claimed in claim 4, wherein a set of plate holding channels 50 are provided on the first cover 10 to retain and hoard the plate 40 in the uncovered position.

7. A lockout device 100 as claimed in claim 1, wherein the first cover 10 is configured to support the add-on cover, and the second cover 20 comprises:
a first quadrant 21 to cover a part of the second portion; and
a second quadrant 22 to cover a remaining part of the second portion;
wherein the first quadrant 21 and the second quadrant 22 are coupled to the first cover 10 and configured to rotate about an axis extending perpendicular to the plane to selectively enclose the handle.

8. A plate 40 to cover the top aperture 30 of a lockout device as claimed in claim 2.

9. The plate 40 as claimed in claim 8, wherein the plate 40 has a first end configured to be supported by the set of guide channels 12 provided on the first cover 10 and a second end 41 configured to cover the top aperture 30.

10. The plate 40 as claimed in claim 8, wherein the second end 41 is semi-circular in shape.

11. A lockout device 100 as claimed in claim 1, wherein the aperture is a bottom aperture 60 to accommodate a stem of the valve extending below and through the bottom surface of the lockout device 100, and the add-on cover is a bush 70 adapted to extend from the bottom aperture 60 and covers at least a portion of the stem to prevent tampering with the valve.

12. A lockout device 100 as claimed in claim 11, wherein the first cover 10 and the second cover 20 are provided with annular grooves 14 proximate to the bottom aperture to support the bush 70.

13. A bush 70 to cover the bottom aperture 60 of a lock out device 100 as claimed in claim 11.

14. A bush 70 as claimed in claim 13, wherein the bush comprises:
a flange portion 71 configured to be supported by the first cover 10 and the second cover 20; and
a cylindrical wall 72 portion adapted to cover the at least portion of the stem.

15. A bush 70 as claimed in claim 13, wherein the bush 70 has a cut 73 extending along its longitudinal axis to allow entry of the stem in the bush.

16. A lockout device 100 as claimed in claim 7, wherein the lockout device 100 comprises:
a first sleeve 211 projecting outwardly from outer periphery of the first quadrant 21, the sleeve 211 including at least one first locking aperture 212; and
a second sleeve 221 projecting outwardly from outer periphery of the second quadrant 22, the sleeve 221 including at least one second locking aperture 222;
wherein the first locking aperture 212 is configured to align with the second locking aperture 222 when the lockout device is the closed condition, for receiving a locking device for securing and retaining the lockout device 100 in closed condition.
